(19) United States
(12) Patent Application Publication
(10) Pub. No.: US 2026/0327981 A1
(43) Pub. Date: Oct. 22, 2026

(54) PANEL SYSTEM

(71) Applicant: B Bond Beyond Technology Ltd

(72) Inventors: Dechawathr DULSAPSOPONT, Bangkok (TH); Surachai THONGKAEW, Pathum Thani (TH)

(73) Assignee: B Bond Beyond Technology Ltd, (omitted)

(21) Appl. No.: 19/113,927

(22) PCT Filed: Sep. 21, 2022
(86) PCT No.: PCT/TH2022/000035

§ 371 Date: Mar. 21, 2025

(51) Int. Cl. E04C 2/52; G01D 5/14; H02G 3/38

(52) U.S. Cl. CPC E04C 2/526; G01D 5/142; H02G 3/38

(57) ABSTRACT

The present invention provides a panel system with installation support module to facilitate adjustable positioning of devices thereon so that a user can easily and securely move the devices to any position on the panel any time when required. In addition, the panel system comprises a processor in connection with the attached devices, where the processor is configured to process desired data from the devices requested by the user. Since the device allows adjustable positioning, the data collected from the devices can be used for executing a plurality of functions.

### FIELD OF INVENTION

The present invention relates to fields of engineering and construction, specifically the present invention relates to a panel system with installation support module to facilitate adjustable positioning of devices thereon.

### BACKGROUND OF INVENTION

A house or building structure often comprise walls which are made of brick and concrete. The walls can be decorated with tile, wood or painting for interior design purposes. Installation and dismantling of the wall requires expert technicians to carry out the construction which consumes a lot of time with high labor costs. When a householder needs to renovate their house, the walls sometimes need to be demolished and cannot be recycled and reused. In addition, dust from demolition is considered as pollution waste.

Nowadays there are walls being developed using frames covered with panel plates in order to reduce the use of concrete, and also integrating internet of things (IoT) devices providing smart home facilities to residents. Currently, devices such as sensors, touch screen displays, speakers, or smart appliances, are installed onto walls by mounting with screws and wiring to a power supply. Those devices cause inconvenience to the householder because there is a need to drill the wall for installation, creating an unattractive interior mark on the wall which cannot be concealed. In case that the householder wants to remove the devices, it is necessary to fill and re-paint drilled holes. Moreover, electronic wiring connection of those IoT devices requires a skilled technician to select cables for correct installation. Sometimes those cables have different types of communication protocols that cause complex connections, difficult replacement, and cause a plurality of cables that can be clearly seen on the wall. Therefore, a panel system is being developed which can replace traditional walls. The panel system is designed and assembled to replace walls, floors or ceilings without the need of a skilled technician. Any devices mounted on the system can also be disassembled, reinstalled and reused without any hand tools and without having to worry about construction and destruction issues. In addition, the system has a redesigned electrical system in the wall in order to connect with the devices and respond to the householder's lifestyle without causing any damage to the wall.

U.S. Pat. No. 4,934,119A disclosed a wall panel system having a plurality of panel plates for building walls and partitions. The system comprises a first layer having a floor structure, a ceiling structure, and studs vertically disposed between the floor and ceiling structures; a second layer having a plurality of magnetic clips installed on the studs and secured by bolts; a third layer having a plurality of panels, where each panel has magnetic members on the rear side adjacent to its vertical edges for attachment/detachment on the magnetic clips. When the panel plate is placed in position on the system assembly, the panel is held in place by the magnetic attraction between the magnetic clips and magnetic members. The panel plates may be removed and replaced quickly and easily by even unskilled persons and without disturbing the remaining panels.

U.S. Pat. No. 7,843,296B2 disclosed an attachment device using multiple magnetic structures to enable attachment and detachment of two objects such as panels on a wall. The device comprises a first object embedded with a first magnetic structure, a second object embedded with a two-sided mechanism having one side of a second magnetic structure and another side of a third magnetic structure, and a fourth magnetic structure having a gripping mechanism that would typically be turned by hand. The gripping mechanism could be mounted or replaced by an automation device according to user purpose. The two-sided mechanism may include a separation layer that keeps the magnetic fields of the second magnetic structure from interacting with the magnetic fields of the third magnetic structure. Additionally, the attachment device can be fitted with a magnetic sensor (hall effect sensor) to indicate whether the first object (e.g. a panel) is attached or separated. The magnetic sensor may be connected to a security alarm to indicate unsafe condition and the sensor may operate when the top or bottom part of the first object are separated.

U.S. Pat. No. 10,184,279B2 disclosed a magnetic latch device using fixed magnetic pieces for attachment and detachment. The magnetic latch device comprises a plate formed by a ferromagnetic core and a covering of a polymer material where an RFID tag is integrated within the plate to be readable by an RFID reader, and a housing having a magnet for holding the plate. The magnet may be planar or rectangular ferromagnetic that serves to conduct the flux of the magnet from inside the housing to outside of the housing through the housing wall. The housing contains an RFID reader inside and connects it to an electrical cable for transferring power and signals. When the plate is attached to the magnet of the housing, the RFID tag provides data or a numeric code to the RFID reader.

US20180343741A1 disclosed an array connection of rigid-flex printed circuit board (PCB) in electronic devices by using a flexible PCB formed into flexible connectors as a straight type or 4-way junction type, wherein each connecting part includes power pin (VCC) for electric supply, ground (GND) pin, and multiple signal lines for data communication. This flexible PCB is used as a replacement for traditional cable connecting parts in restricted spaces and tightly positioned electronic devices. The flexible PCB may be multilayer structure to carry required communications comprising one or more layers of conductors, typically copper, separated by insulting layers such as glass, epoxy, or polyimide. For example, four-layer PCB with three intervening insulation layers, where the outer copper layer can be coated with a protective layer for protection against corrosion. However, it does not teach applying fully or partially arranging a cable module to be installed in the panel system, where the panel system is designed to allow adjustable positioning of IoT devices and connection to the cable module to function at the same time.

However, those disclosures are silent about applying a cable module having cables and junction units to be fully or partially integrated into a panel system in order to transmit both power and signals to predetermined positions of devices, where the panel system is designed to allow adjustable positioning of the devices. Moreover, they do not suggest using a processor to connect with all devices through the cable module in order to process obtained data and perform the functions required by the user.

In order to improve the above drawbacks, this invention aims to develop a panel system to replace traditional construction and function as a panel system for arranging a cable module to connect with devices, where the panel system is designed to facilitate adjustable positioning of devices so that a user can easily and securely move the devices to any position on the panel at any time when required. This contrasts to the current system where the devices must be fixed at positions in accordance with the electrical wiring only. In addition, the panel system comprises a processor in connection with the attached devices, where the processor is configured to process desired data from the device requested by the user for executing a plurality of functions.

### SUMMARY OF THE INVENTION

The present invention provides a panel system with installation support module to facilitate adjustable positioning of devices thereon so that a user can easily and securely move the devices to any position on the panel at any time when required. In addition, the panel system comprises a processor in connection with the attached devices, where the processor is configured to process desired data from the devices as requested by the user. Since the device is allowed to be adjustably positioned, the data collected from the device can be used for executing a plurality of functions.

In an embodiment of the present invention, the present invention relates to a panel system (100) comprising:
a plurality of supporting panels (200);
a plurality of mounting modules (300) for supporting installation of device (900), where the mounting modules (300) are configured to lower load of the device (900) upon installation;
at least one cable track (220) formed at at least one edge of the mounting module (300) for supporting a cable module (400);
the cable module (400) installed in the cable track (220);
at least one device (900) in connection to the cable module (400);
a processor (600) in connection to the cable module (400) and the device (900)

wherein the cable module (400) is fully or partially installed in the cable track (220) in a predetermined direction to transmit power and signal to an adjustably predetermined position of the device (900) and the processor (600) is configured to process desired data from the device (900) for executing a plurality of functions.

### BRIEF DESCRIPTION OF THE DRAWINGS

For a more complete understanding of the present invention, examples of embodiments and their advantages, reference is made to the following description taken in conjunction with the accompanying drawings, in which like reference numbers indicate like features. The following figures show perspective views of the example embodiments.

FIG. 1 shows a perspective view of a panel system (100) according to the exemplary embodiments of the invention.

FIG. 2 shows an exploded view of the panel system (100) according to the exemplary embodiments of the invention.

FIG. 3 shows a perspective view of (a) a supporting panel (200) and (b) the supporting panel (200) with an additional panel (202) according to the exemplary embodiments of the invention.

FIG. 4 shows examples of a mounting module (300) according to the exemplary embodiments of the invention.

FIG. 5 shows a cable module (400) installed in the cable track (220) according to the exemplary embodiments of the invention.

FIG. 6 shows an example of a cable (402) according to the exemplary embodiments of the invention.

FIG. 7 shows an example of a junction unit (404) according to the exemplary embodiments of the invention.

FIG. 8 shows an example of a connecting part (406) according to the exemplary embodiments of the invention.

FIG. 9 shows an example structure of the cable (402) according to the exemplary embodiments of the invention.

FIG. 10 shows an example structure of the junction unit (404) according to the exemplary embodiments of the invention.

FIG. 11 shows a permanent electromagnet (502) and a sensing unit (503) according to the exemplary embodiments of the invention.

FIG. 12 shows a perspective view of the sensing unit (503) according to the exemplary embodiments of the invention.

Although similar reference numbers may be used to refer to similar elements in the figures for convenience, each of the various example embodiments may be considered to be distinct variations.

### DETAILED DESCRIPTION OF THE INVENTION

The present disclosure relates to a panel system with installation support module to facilitate adjustable positioning of devices thereon so that a user can easily and securely move the devices to any position on the panel at any time when required. The panel system comprises a processor in connection with the attached devices, where the processor is configured to process desired data from the device requested by the user. In addition, the panel system can support installation of many devices and the devices are allowed to be adjustably positioned thereon. Therefore, big data can be collected and the data collected from the devices can be used for executing a plurality of functions. Any aspect shown herein is meant to include its application to other aspects of this invention unless stated otherwise.

Technical terms or scientific terms used herein have definitions as known to an ordinary person skilled in the art unless stated otherwise.

Any tools, equipment, methods, or chemicals named herein mean tools, equipment, methods, or chemicals being used commonly by an ordinary person skilled in the art unless expressly stated that they are tools, equipment, methods, or chemicals specific only to this invention.

Use of a singular noun or pronoun with “comprising” in claims or specification means “one” but may also refer to “one or more,” “at least one,” and “one or more than one.”

All components and/or methods disclosed and claims in this application aim to cover embodiments from any action, performance, modification, or adjustment without any experiment that significantly differs from this invention, which would result in creation of an object with the same utility or which would be deemed substantially similar to the present embodiment according to an ordinary person skilled in the art, whether or not such variation is specifically stated in the claims. Therefore, objects that are similar or which may be substitutable for the present embodiment, including those with minor modifications or adjustments that may be clearly devised by an ordinary person skilled in the art should be construed as being within the spirit, scope, and concept of invention as appeared in the appended claims.

Throughout this application, the term “about” means any number referenced herein that could be varied or deviated from any error of equipment, method, or person using said equipment or method.

Example aspects will now be described with reference to the accompanying drawings, which form a part of the present disclosure and which illustrate example embodiments which may be used. As used in the present disclosure and the appended claims, the terms “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims are for the purpose of describing example embodiments only, and is not intended to limit interpretation. In this respect, as used in the present disclosure and the appended claims, the term “in” may include “in” and “on,” and the terms “a,” “an,” and “the” may each refer to the singular and plural. Furthermore, as used in the present disclosure and the appended claims, the term “by” may also mean “from,” depending on the context; the term “if” may also mean “when” or “upon,” depending on the context; and the term “and/or” may refer to and encompass any and all possible combinations of one or more of the associated listed items.

The term “device” (900) used in the present disclosure include all electrical devices which need or need not connect to the internet, for example display devices (e.g. television, touch screen displays and the like), video projectors and audio systems, closed-circuit television (CCTV), surveillance cameras, solar cells, solar panels, chargers, water dispensers, air purifiers, and any common electrical devices (e.g. one or more lights, light measurement controllers, air conditioners, fans, kitchen devices, and the like), sensors for detecting environmental factors such as vibration sensors, humidity sensors, smoke detectors, light sensors, temperature sensors and the like. The device (900) may be connected to the panel system (100) to transmit either power or signal, or both power and signal from the cable module (400) of the panel system (100).

The terms, “touch”, “connect”, “connecting”, “connection”, “connected”, “in connection with”, “attach”, “attaching”, “attachment”, “attached”, “install”, “installed”, “installing”, installation”, “mount”, “mounting”, “mounted” and/or the like may be interchangeably used to refer to or mean direct electronic or physical connection or connection via one or more elements, whether or not power and/or signal are transmitted between such elements, where the connecting parts can be in any type of electrical connector/or physical mechanism.

The terms “temporarily attach”, “temporarily attached”, “temporarily attaching”, “temporarily attachment”, and/or the like used herein means temporarily attaching between the device (900) and the permanent electromagnet, while the magnetic field of the permanent electromagnet (502) is reduced in proportion to the amount of electrical current applied.

The terms “fully attach”, “fully attached”, “fully attaching”, “full attachment”, and/or the like used herein means fully attaching between the device (900) and the permanent electromagnet, while the permanent electromagnet is in full magnetized stage with no electrical current applied. Although the magnetic field decreases with magnetic degradation over time, if there is no electrical current applied, the permanent electromagnet is still considered as fully attaching the device (900). The term “initial magnetic field” means the magnetic field of the permanent electromagnet that is detectable during one or more detection periods, before applying electrical current to the permanent electromagnet in order to partially reduce the magnetic field of the permanent electromagnet. The initial magnetic field is detected when the user starts using the system (100). The initial magnetic field may be equivalent to the capacity of the permanent electromagnet from the manufacturer.

The term “pre-stage magnetic field” means the magnetic field of the permanent electromagnet that is detectable during one or more detection periods, while the permanent electromagnet is in the state of partially reducing the magnetic field from the initial magnetic field in proportion to the amount of electrical current applied.

The term “post-stage magnetic field” means the magnetic field of the permanent electromagnet that is detectable during one or more detection periods, while the permanent electromagnet is in fully magnetized stage with no or insufficient electrical current applied.

The term “pre-stage compression force” means the compression force between the device (900) and the permanent electromagnet, that is detectable during one or more detection periods, while the permanent electromagnet is in the state of partially reducing the magnetic field from the initial magnetic field in proportion to the amount of electrical current applied.

The term “post-stage compression force” means the compression force between the device (900) and the permanent electromagnet, that is detectable during one or more detection periods, while the permanent electromagnet is in fully magnetized stage with no or insufficient electrical current applied.

Hereafter, embodiments of the invention are elucidated to show details of the invention by way of explanatory embodiments. The breadth and scope of the present invention should be defined only in accordance with the claims and their equivalents issuing from this disclosure.

In one embodiment of the invention, the present invention relates to a panel system (100) comprising:
a plurality of supporting panels (200);
a plurality of mounting modules (300) for supporting installation of device (900), where the mounting modules (300) are configured to lower load of the device (900) upon installation;
at least one cable track (220) formed at at least one edge of the mounting module (300) for supporting a cable module (400);
the cable module (400) installed in the cable track (220);
at least one device (900) in connection to the cable module (400);
a processor (600) in connection to the cable module (400) and the device (900)

wherein the cable module (400) is fully or partially installed in the cable track (220) in a predetermined direction to transmit power and signal to an adjustably predetermined position of the device (900) and the processor (600) is configured to process desired data from the device (900) for executing a plurality of functions.

In another exemplary embodiment, the system (100) further comprises at least one additional panel (202) attached back-to-back of the supporting panel (200).

In another exemplary embodiment, the system (100) further comprises a securing module (206) to securely attach supporting panels (200) with additional panel (202).

In another exemplary embodiment, the supporting panel (200) and additional panel (202) are the same or different size.

In another exemplary embodiment, the system (100) further comprises an insulating material (204) provided between the supporting panel (200) and the additional panel (202).

In another exemplary embodiment, the cable module (400) comprises at least one cable (402) and at least one junction unit (404).

In another exemplary embodiment, the cable (402) and the junction unit (404) are printed circuit board (PCB).

In another exemplary embodiment, the cable (402) comprises
two connecting parts (406) located at both ends of the cable (402);
a first conductive material layer (412);
an insulation layer (413) attached under the first conductive material layer (412);
a second conductive material layer (414), attached under the insulation layer (413), where the second conductive material layer (414) comprises a ground plane and a power plane.

In another exemplary embodiment, the cable (402) further comprises mask layers (420) disposed on the first conductive material layer (412) and on the second conductive material layer (414) for preventing oxidation of the conductive material.

In another exemplary embodiment, the junction unit (404) comprises
at least three connecting parts (406) located at the end of the junction unit (404);
a first conductive material layer (432), where the first conductive material layer (432) comprises a power plane;
an insulation layer (433) attached under the first conductive material layer (432);
a second conductive material layer (434), attached under the insulation layer (433), where the second conductive material layer (434) comprises a ground plane.

In another exemplary embodiment, the junction unit (404) further comprises mask layers (440) disposed on the first conductive material layer (432) and on the second conductive material layer (434) for preventing oxidation of the conductive material.

In another exemplary embodiment, the connecting part (406) comprises at least one pin of Voltage Common Collector (VCC), at least one pin of ground (GND), and at least one pin of signal.

In a preferred exemplary embodiment, the connecting part (406) comprises 3-pin Voltage Common Collector (VCC), 4-pin ground (GND), and 4-pin of signal.

In another exemplary embodiment, the type of the signal is selected from RS-232, RS-422, RS-423, RS-485, I²C, Ethernet, SDI-12, 1-Wire or combination thereof.

In a preferred exemplary embodiment, the type of the signal is RS-485.

In another exemplary embodiment, the mounting module (300) further comprises:
at least one permanent electromagnet (502) for mounting the device (900), where the permanent electromagnet is in fully magnetized stage with no electrical current applied;
a sensing unit (503) configured to sense the device (900) attached on the permanent electromagnet (502), comprising
   at least one identity detecting unit (504) for detecting an identity of the device (900);
   at least one magnetic detecting unit (506) for detecting a magnetic field between the device (900) and the permanent electromagnet (502);
   at least one compression detecting unit (508) for detecting a compression force between the device (900) and the permanent electromagnet (502).

In another exemplary embodiment, the processor (600) further configured to control the identity detecting unit (504), magnetic detecting unit (506) and compression detecting unit (508). In another exemplary embodiment, the mounting module (300) is further configured to:
i) partially reducing a magnetic field from an initial magnetic field of the permanent electromagnet (502) by applying a power thereto;
ii) detecting a magnetic field via the magnetic detecting unit (506) and a compression force via the compression detecting unit (508), when the device (900) is mounted to the permanent electromagnet (502) by a user;
iii) receiving and verifying the identity of the device (900) from the identity detecting unit (504), if the identity of the device (900) is not accurate, the processor (600) will notify the user;
iv) terminating applying the power to fully attach the device (900) after receiving to the user's instruction.

wherein step i) the electrical current will be applied in order to reduce the magnetic field of the permanent electromagnet (502) to be able to temporarily attach at least 70% of weight of the object.

It should be understood that examples of the invention described hereinafter have been presented by way of explanatory and exemplary embodiments of the present invention only. Thus, the breadth and scope of the present invention should be defined only in accordance with the claims and their equivalents issuing from this disclosure.

### EXAMPLE EMBODIMENTS

These example embodiments of the invention will now be described below with reference to the accompanying drawings, which form a part of the present disclosure.

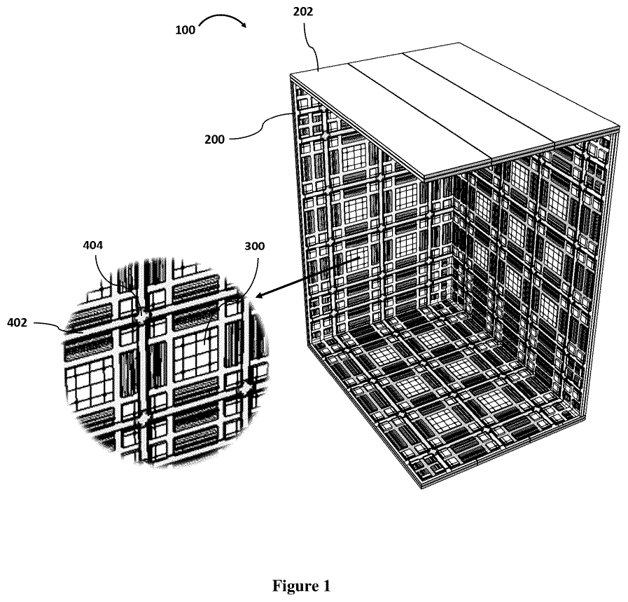

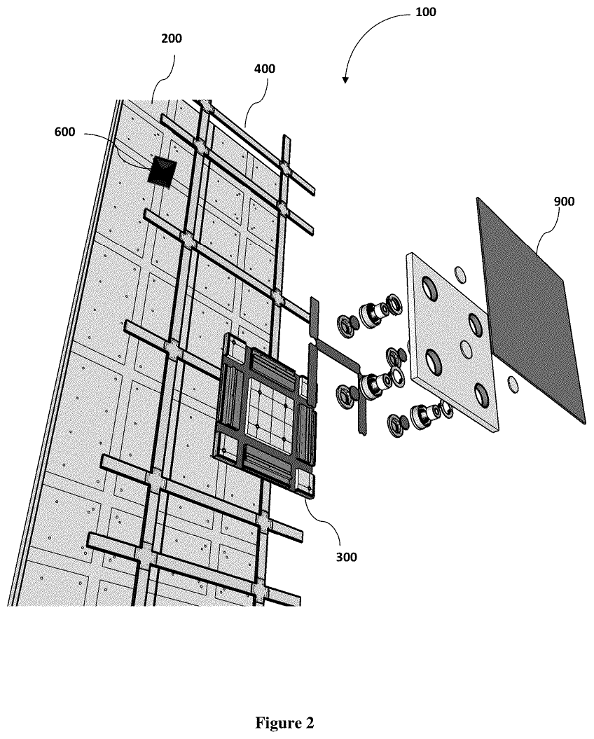

FIG. 1 and FIG. 2 shows a panel system (100) according to the exemplary embodiments of the invention. The panel system (100) comprises a plurality of supporting panels (200), a plurality of mounting modules (300) installed on the supporting panel (200) for mounting at least one device (900) thereon, at least one cable track (220) formed at at least one edge of the mounting module (300) for supporting a cable module (400) (as shown in FIG. 2), the cable module (400) installed in the cable track (220), at least one device (900) in connection to the cable module (400), and a processor (600) in connection with the cable module (400) and the device (900). The cable module (400) is configured to be fully or partially installed in the cable track (220) in a predetermined direction to transmit power and signal to an adjustably predetermined position of the device (900). The processor (600) is configured to process the desired data from the device (900) requested by a user for executing a plurality of functions.

A plurality of the panel system (100) may be assembled serially adjacent to form a larger size panel, such as wall, ceiling or floor. In addition, the panel system (100) may be installed on a traditional wall of building to improve the traditional wall to have functionality of the panel system (100). The panel system (100) may also be arranged to form an angle from 5 to 180 degree, so that the panel system (100) can form a corner and/or a room with any shapes according to user purpose. For example, the first panel system (100) may be arranged to form a wall on one side (1^{st} side) of the room and the second panel system (100) may be arranged to form a wall on the adjacent side (2^{nd} side) of the 1^{st} side in order to create a corner for mounting any devices (900).

The mounting modules (300) are installed on the supporting panel (200) in accordance with predetermined position for mounting the devices (900), where there are gaps between the mounting modules (300) to form the cable track (220). Those gaps are used to arrange the cable tracks (220) for supporting installation of the cable module (400). The cable module (400) comprises at least one cable (402) and at least one junction unit (404), connecting in a manner of array connection for transmitting power and signal. After installation of the panel system (100) is done, a user provides the devices (900) to mount on the mounting module (300) and connect those devices (900) to the cable module (400) in a manner of plug and play. Moreover, the cable (402) and the junction unit (404) are preferably formed by printed circuit boards (PCB) to connect with the devices (900) rather than traditional cable connecting part, and with transmitting power and signal through the PCB, all of the devices (900) can be controlled and can function at the same time.

The processor (600) may be designed to connect with the devices (900) installed on the system panel (100). The processor (600) can select the desired data transmitted from each device (900) and perform a calculation for automated data analysis in order to perform some functions in accordance with the needs of the user.

For example, if a device (900) is a vibration sensor mounted on the mounting module (300) of the panel system (100), the vibration sensor can detect vibrating data within the environment in real time and transmit the vibrating data to the processor (600). The vibration sensor mounted on the mounting module (300) can easily be adjusted and/or moved to any predetermined position so that the vibration sensor will be in the appropriate position for effectively detecting data. After transmission of the vibrating data from the vibration sensor to the processor, the processor (600) analyzes such vibrating data and when an earthquake occurs the vibrating data will be inevitably high to peak, and the processor (600) can detect abnormal data and notify to the user immediately.

In addition, for optimal results, multiple types of sensors may be mounted on the mounting module (300) for certain purposes. For example, vibration sensor and smoke detector may be installed on the mounting modules (300) to obtain multiple environmental data. The environmental data obtained from the multiple types of sensors will be transmitted to the processor (600) in order to process. For example, if the processor (600) detects abnormal environmental data from the multiple types of sensors, the processor (600) will notify to the user immediately.

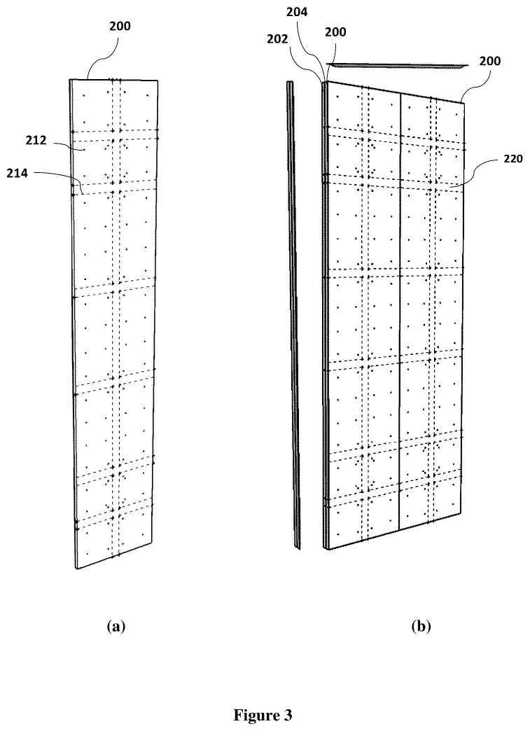

FIG. 3 shows a perspective view of the supporting panel (200) and an additional panel (202) according to the exemplary embodiments of the invention. The additional panel (202) is attached back-to-back with the supporting panel (200). Each supporting panel (200) may comprise at least one hole (212) for holding the mounting module (300), and at least one reference line (214) for predetermining the position of mounting module (300) to be installed. The supporting panel (200) is designed, such as in the form of rectangular shape with specific dimension, a length from 600 to 3000 mm and a width from 200 to 1200 mm and a thickness from 30 to 300 mm

In use case, the supporting panel (200) and the additional panel (202) can be different sizes, both length and width. However, usually the length of the supporting panel (200) corresponds to the height of the installation room. If the user arranges the supporting panel (200) to fit with the height of the installation room, a plurality of smaller additional panels (202) may be assembled to comply with the dimension of the supporting panel (200).

The panel system (100) further comprises a securing module (206) to secure between the supporting panel (200) and the additional panels (202), and reinforce the panel system (100), where the securing means (206) may be mechanical parts such as mounting track or locking bolt. The panel system (100) may comprise an insulating material (204) provided between the supporting panel (200) and the additional panel (202) as a flame retardant, and/or for preventing the loss of heat, and intrusion of sound. The insulating material (204) is selected from aerogel, poly(methyl cyanoacrylate), polyurethane, fiberglass or combination thereof.

The supporting panel (200) and the additional panel (202) are not limited to only a rectangular shape, but other geometric shapes such as triangle, circle, trapezoid, honeycomb and the like can also be used, as long as the supporting panel (200) and the additional panel (202) can be assembled and connected in many ways to construct the panel system (100) efficiently, without any purpose to limit any scope of the invention. The material of the supporting panel (200) and the additional panel (202) may be independently selected from aluminum, fiberglass, steel, stainless steel, cast iron, Poly Vinyl Chloride (PVC), Polyethylene Terephthalate (PET), Polystyrene (PS), Polypropylene (PP), Low Density Polyethylene (LDPE), High Density Polyethylene (HDPE), wood, reinforced rubber, tempered glass, multi-layered material or combination thereof, which needs strength, durability and lightweight to be suitable for installation without heavy-duty tools.

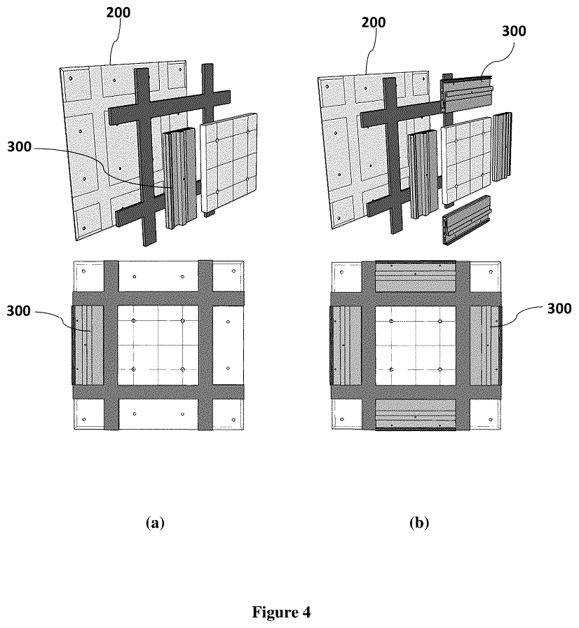

FIG. 4 shows examples of the mounting module (300). The mounting module (300) may be a one-piece structure located on one side of the supporting panel (200) (FIG. 3a), where one side of the structure is installed on the supporting panel (200) and another side has a mounting means to mount the device (900) thereon. Likewise, the mounting module (300) may be configured to be located on the additional panel (202) for mounting the device (900). With the mounting means the user can mount the devices (900) on the panel system (100) via the mounting module (300) without the need of using tools (e.g. using a drill and wall screw) to assist in mounting. This makes the device (900) installation on Panel system (100) safer. Alternatively, multiple mounting modules (300) (FIG. 3b) may be located at many or all sides of the supporting panel (200) in order to add more mounting positions to mount multiple devices (900) effectively.

A number of mounting modules (300) may be equal to or greater than the number of the devices (900), where the mounting modules (300) are adjustably positioned to be installed at a predetermined position according to the adjustably predetermined position of the devices (900). There may be one or more mounting module (300) installed on the supporting panel (200) to support future installation of more devices (900). The mounting modules (300) may be installed in the position according to the predetermined position of the devices (900). For example, the mounting modules (300) may be fully installed on the supporting panel (200) at predetermined reference line (214) and, in actual use, those mounting modules (300) do not need to be installed with all devices (900) thereon because the user may mount one device (900) at any position of the mounting modules (300). Therefore, the user can select the predetermined position to install device (900) and be able to adjust the position independently.

When the mounting modules (300) are installed on the supporting panel (200) in a manner of array with gap between each other, a plurality of gaps are created and the thickness of the mounting modules (300) causes those gaps to be formed into rectangular tracks in order to be used as the cable tracks (220) for supporting the cable module (400). In an additional case, the cable track (220) may be formed by creating track groove on the supporting panel (200), such as rectangular groove, oval groove, V-groove, J-groove, U-groove, bevel-groove, or combination thereof. The cable track (220) may be added with additional liner such as rubber liner, plastic liner, metal liner, or aluminum liner to be embedded into the cable track (220) for protection against short circuits between the cable (402) and the material of supporting panel (200). The cable track (220) may have a width from 5 to 50 mm and a depth from 10 to 50 mm, or according to the dimension of the cable (402).

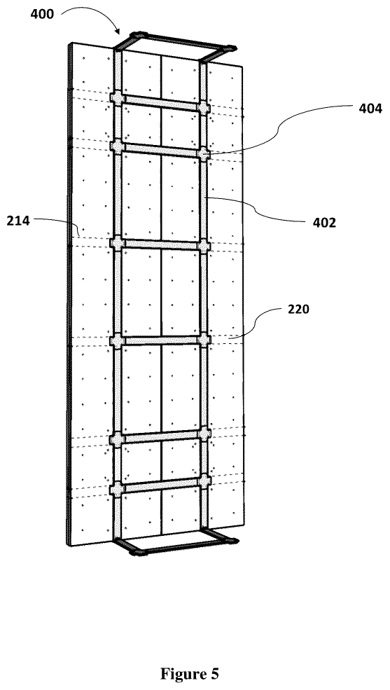

The cable module (400) installed in the cable track (220) comprises at least one cable (402) and at least one junction unit (404) as shown in FIG. 5, where each cable (402) is positioned at the edge of the mounting module (300), while each junction unit (404) is positioned at the corner of the mounting module (300). Those cables (402) and junction units (404) are connected in a manner of array, or any form of arrangement according to the layout of the reference lines (214), for example, horizontal arrangement, vertical arrangement, square arrangement, circular arrangement, or combination thereof. Moreover, the cable (402) and the junction unit (404) may be connected together to form an angle from 5 to 180 degrees for routing the cable (402) to any position. Once the cable module (400) is installed in the cable track (220), an outsource power is connected to the cable module (400) for supplying power.

The cable module (400) may be fully or partially installed in the cable track (220) in a predetermined direction to transmit power and signal to an adjustably predetermined position of the devices (900), where the predetermined direction of the cable module (400) is configured to systematically line up with the predetermined position of the mounting modules (300). For optimal cost savings, the cable module (400) may be designed with a layout with the shortest direction.

For example, the cable module (400) may be installed in all cable tracks (220) to support a large number of devices (900) to be installed such as in the entertainment room, gaming room, exhibition room, and the likes. In addition, the cable module (400) may also be fully installed in all cable tracks (220) to support additional devices (900) to be installed in the future. Alternatively, the cable module (400) may be installed in some cable tracks (220) (partial installation) to support only a limited number of devices (900) so that the cost would be reduced. For a specific example, if the user would like to install only three devices (900), partial installation of the cable module (400) would be sufficient.

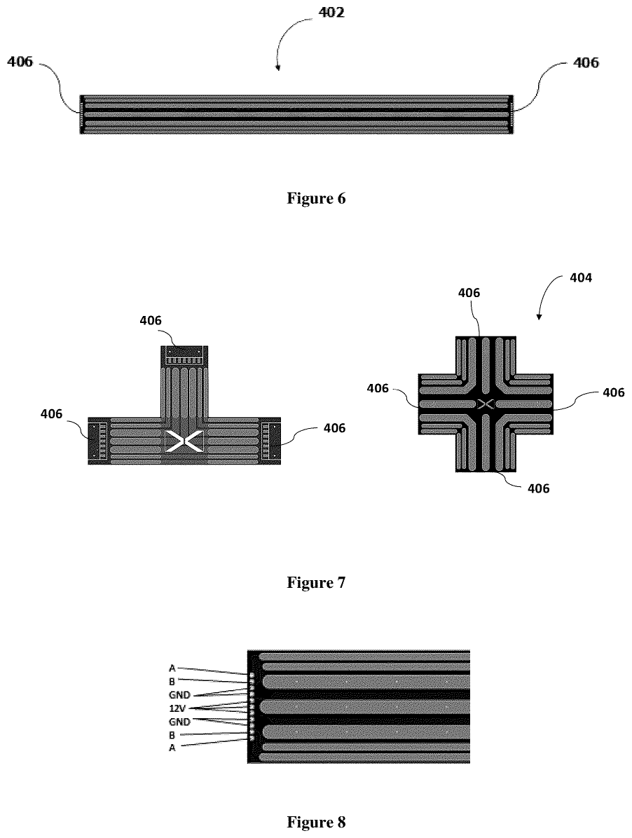

FIG. 6 shows the cable (402) which has two connecting parts (406) located thereon for connecting the cable (402) to the junction unit (404). The cable (402) is used to transmit power and signal throughout the panel system (100). The cable (402) may be in length from 100 to 1000 mm, and width from 10 to 50 mm.

FIG. 7 shows the junction unit (404) having at least 3 connecting parts (406) that can be formed as 3-way or 4-way junction for connecting the junction unit (404) to the cable (402). The junction unit (404) may be in length from 10 to 500 mm and width from 10 to 500 mm to correspond with the cable.

An example of the connecting part (406) is shown in FIG. 8, comprising 7-pin; 3-pin Voltage Common Collector (VCC), 4-pin ground (GND), 4-pin signal. The voltage of VCC can be either 5V DC, 12V DC or 24V DC. The signal may be selected from RS-232, RS-422, RS-423, RS-485, I²C, Ethernet, SDI-12, 1-Wire or combination thereof, preferably RS-485, or can be determined from the specification of the device (900). Using more than 4-pin signal for data transmission allows the cable module (400) to support connecting up to 100 devices (900) at the same time. The cable (402) and junction unit (404) may be adjusted in accordance with the configuration of the connecting part (406) to support more devices (900) according to the number of devices (900) that users need.

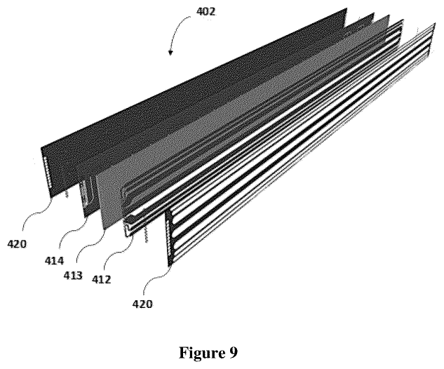

FIG. 9 shows an example structure of the cable (402). The cable (402) is formed by printed circuit board (PCB) comprising two connecting parts (406), and at least two layers of conductive material comprising a first conductive material layer (412); a second conductive material layer (414), positioned under the first conductive material layer (412) by attaching with an insulation (413), where the second conductive material layer (414) comprises a ground plane and a power plane; and mask layers (420) disposed on the first conductive material layer (412) and on the second conductive material layer (414) for preventing oxidation of the conductive material.

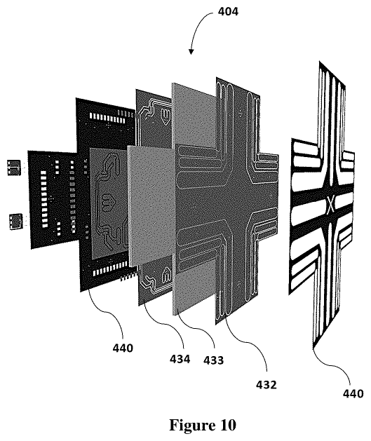

FIG. 10 shows an example structure of the junction unit (404). The junction unit (404) is formed by printed circuit boards (PCB) comprising at least three connecting parts (406) protruding from the junction unit (404), and at least two layers of conductive material comprising: a first conductive material layer (432), where the first conductive material layer (432) comprises a power plane; a second conductive material layer (434), positioned under the first conductive material layer (432) by attaching with an insulation (433), where the second conductive material layer (434) comprises a ground plane; and mask layers (440) disposed on the first conductive material layer (432) and on the second conductive material layer (434) for preventing oxidation of the conductive material. The junction unit (404) further comprises at least one circuit switching unit configured to switch a signal path on the junction unit.

The conductive material allows the electrons flowing through the layer for transmitting electric current of the circuit, where examples of the conductive material include, but are not limited to, aluminum, an aluminum alloy, copper, a copper alloy, tungsten, a tungsten alloy, gold, a gold alloy, silver, a silver alloy or combination thereof. The insulation disclosed in the exemplary embodiments of the invention is not only the layer of insulation that is the same size as the conductive material layer, but the insulation can also be an interposing material used to separate two conductive material layers for preventing short circuit. The insulation can be a material such as fiberglass-epoxy laminate, polytetrafluoroethylene (PTFE), and the like, that is used for, but not limited to, coating, spraying, painting, airbrushing, or adhering on the conductive material layers in order to function as electrical protection.

Moreover, the cable (402) and the junction unit (404) may be shielded with an additional polymer coating (e.g. PVC) to prevent short circuits and to filter electromagnetic waves that interfere with data communication. The cable (402) and the junction unit (404) described herein in terms of a PCB having two layers are merely exemplary and are not intended to limit the disclosure. Increasing/decreasing the number layers of the PCB for the panel system (100) as described in the technical concept of this embodiment can be adjusted and it is not considered apart from the scope of the present invention.

Although the present disclosure describes the PCB for transmitting power and/or signal to the devices (900), it is to be understood by a skilled person that the cable (402) and the junction unit (404) may also be other types of electrical cables which are capable of transmitting power and/or signal to the devices (900), for example, coaxial cable, communications cable, direct-buried cable (DBC), flexible cable, heliax cable, and the like.

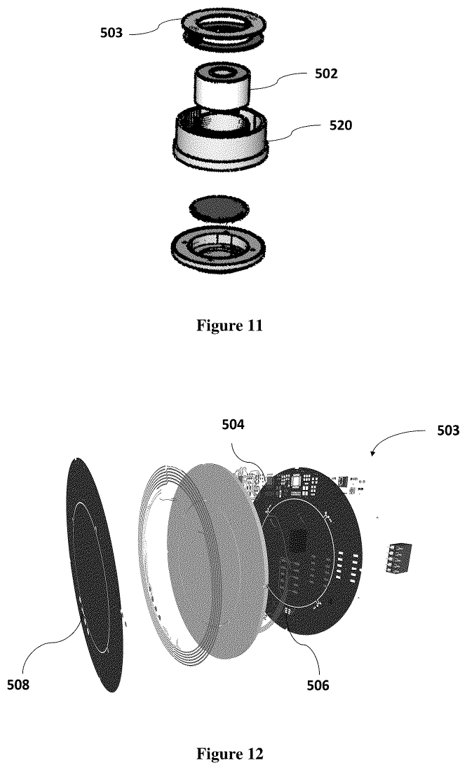

The mounting module (300) may further comprise at least one permanent electromagnet (502) for mounting the device (900) where the permanent electromagnet (as shown in FIG. 11) is in fully magnetized stage with no electrical current applied, and a sensing unit (503) (as shown in FIG. 12) configured to sense the device (900) attached on the permanent electromagnet (502). The sensing unit (503) comprises at least one identity detecting unit (504) for detecting the identity of the device (900), at least one magnetic detecting unit (506) for detecting the magnetic field between the device (900) and the permanent electromagnet (502), and at least one compression detecting unit (508) for detecting the compression force between the device (900) and the permanent electromagnet (502).

The permanent electromagnet (502) is a type of magnet that is always in a state of being fully magnetized when there is no electrical current applied. However, when a user partially applies the electrical current to the permanent electromagnet (502), it would partially reduce the amount of magnetic field. With this characteristic of permanent electromagnet (502), it can be used to temporarily attach the device (900) or temporarily hold the device (900) while installing the device (900) on the permanent electromagnet (502). While temporarily attaching the device (900), the permanent electromagnet (502) supports partial weight of the device (900) for a period, where the user can conveniently adjust the device (900) by rotating or moving the device (900) with less force. After the user adjusts the position of the device (900), the user may stop applying the electrical current to let the permanent electromagnet (502) be fully magnetized for fully attaching the device (900).

The permanent electromagnet (502) may be configured to receive input of user's instructions in order to reduce the magnetic field. For example, the user may input the instruction allowing the permanent electromagnet (502) to be able to temporarily attach at least 70% of the weight of the device (900), where the processor (600) may automatically determine the amount of electrical current applied to the permanent electromagnet (502) by calculation based on a size of magnet and weight of the device (900). The permanent electromagnets (200) may be designed to have holding capacity of 5 to 100 kg for attaching devices (900). The permanent electromagnet (502) can also be applied to facilitate the user in supporting heavy and/or large devices (900) used in manufacturing facilities or industrial plants (e.g. metal sheets, pipes, industrial equipment, and likes). The permanent electromagnet (502) may be designed to have a holding capacity of up to 15,000 kg depending on the device (900), without any purpose to limit any scope of the invention.

The sensing unit (503) may be covering with a housing (520). The housing (520) may be formed in a geometric shape selected from a ring, triangle, circle, trapezoid, hexagon and the like. The housing (520) may be a rigid casing that protects the identity detecting unit (504), the magnetic detecting unit (506), the compression detecting unit (508) and the processor (600) from damage. The sensing unit (503) according to the example embodiment may be designed in a ring shape housing (520) with a thickness from 5 to 30 mm and a diameter from 20 to 100 mm.

As shown in FIG. 12, the identity detecting unit (504) of the sensing unit (503) is disposed inside the sensing unit (503) for detecting the identity of the device (900) and transmitting such identity to the processor (600). The identity is basic information of the device (900) including designed position, trade name, size, type, model, weight, delivery tracking, production date and the likes. The basic information indicates the identity of the device (900) when the user buys and/or sells said device (900). The user can ensure that the device (900) is exactly as its design or it is a genuine device (900) certified by the manufacturer. For example, the identity detecting unit (504) may comprise a Radio-Frequency IDentification (RFID) unit with RFID antenna (303) for receiving the identity of an RFID tag inside the device (900). After the identity detecting unit (504) detects the identity of the device (900), the processor (600), connected to the identity detecting unit (504), verifies the identification result by comparing the identity of the device (900) with identity data. The identity is verified in terms of true (accurate) or false (inaccurate) condition. If the identification result is false, the processor (600) will send a notification to the user to check the device (900). The identity data is the data (for example: product name, product model, production date, expiration date, batch number, lot number, size, dimension, weight, color, material, or combination thereof) generated by the manufacturer where the device (900) was made. This may be collected into a cloud system for an online platform. The processor (600) can be designed to connect and retrieve the identity data as an online mode and/or offline mode.

The magnetic detecting unit (506), disposed on the bottom side of the sensing unit (503), is configured to detect the magnetic field between the permanent electromagnet (502) and the device (900). The magnetic detecting unit (506) detects the initial magnetic field. While the user partially reduces the magnetic field from the initial magnetic field of the permanent electromagnet (502) for temporarily attaching the device (900), the magnetic detecting unit (506) will detect the magnetic field in terms of a pre-stage magnetic field. The user can move the device (900) easily without having to exert a lot of force, because the permanent electromagnet (502) partially supports weight of the device (900) (for example, supports at least 70% of weight of the device (900)). After that, if the user terminates applying the electrical current to the permanent electromagnet (502) such that the device (900) is fully attached to the permanent electromagnet (502), the magnetic detecting unit (506) will detect a post-stage magnetic field for monitoring magnetic degradation of the permanent electromagnet (502). If the post-stage magnetic field of the permanent electromagnet (502) is lower than −20% of maximum magnetic field of the permanent electromagnet (502), preferably −10% of maximum magnetic field, the processor (600) will send the notification to the user that the permanent electromagnet (502) is degraded and may need to be replaced.

The magnetic detecting unit (506) may be a sensor for detecting the magnetic field such as hall sensor. The hall sensor may be designed to detect the magnetic field from 2,000 to 10,000 gauss (G). However, the magnetic detecting unit (506) may be adjusted for the range of detecting the magnetic field depending on the capacity of permanent electromagnet (502) and the weight of device (900).

The compression detecting unit (508), disposed on the top side of the sensing unit (503), is configured to detect the compression force exerted between the permanent electromagnet (502) and the device (900). The compression detecting unit (508) detects the compression force in terms of a pre-stage compression force when the user temporarily attaches the device (900) to the permanent electromagnet (502). The user can move the device (900) easily without having to exert a lot of force because the partial weight of the device (900) is supported by magnetic field from the permanent electromagnet (502). However, if the pre-stage compression force is not within the predetermined value of the pre-stage compression force, the processor (600) will send the notification to the user. The pre-stage compression force may not be within a predetermined value if the device (900) is attached incorrectly (such as wrong position, wrong alignment and/or inaccurate angle) or there is an interference between the device (900) and the permanent electromagnet (502) (such as plastic sheet as barrier). The predetermined value of the pre-stage compression force may be determined based on weight of the device (900), shape of the device (900), an angle between the device (900) and the permanent electromagnet (502), vertical or horizontal installation of the device (900), or combination thereof. Moreover, the processor (600) may monitor whether there is a change of pre-stage compression force, and if there is no change for a predetermined period of time, the processor (600) will send the notification to the user whether to fully attach the device (900).

When the user instructs the system to terminate applying the electrical current to the permanent electromagnet (502) such that the device (900) is fully attached to the permanent electromagnet (502), the compression detecting unit (508) will detect the post-stage compression force for monitoring attaching performance and monitoring compressive strength on the device (900). In the case of the attaching performance, if the post-stage compression force between the device (900) and the permanent electromagnet (502) is lower than −20% of predetermined value of the compression force, preferably −10% of predetermined value of the compression force, the processor (600) will send the notification to the user that the attaching performance is less and the device (900) may fall-off. On the other hand, in the case of the compressive strength, if the post-stage compression force between the device (900) and the permanent electromagnet (502) is higher than +20% of predetermined value of the compression force, preferably +10% of predetermined value of the compression force, the processor (600) will send the notification to the user that the device (900) is under high compression which may damage to the device (900). The predetermined value of the compression force may be an initial value of post-stage compression force when the device (900) is fully attached on the permanent electromagnet (502). In some case, the predetermined value of the compression force may be determined from the manufacturer, where it is calculated based on weight of the device (900), shape of the device (900), an angle between the device (900) and the permanent electromagnet (502), vertical or horizontal installation of the device (900).

The compression detecting unit (508) may be a sensor for detecting the compression force, such as force sensor or strain gauge. The force sensor may be designed to detect the compression force from 20 to 1,000 newton (N). However, the compression detecting unit (508) may be adjusted for the range of detecting the compression force depending on the capacity of permanent electromagnet (502) and the weight of device (900).

The sensing unit (503) further comprises a connecting unit (not shown here) located on one side of the sensing unit (503) for electrical connection between the sensing unit (503) and the device (900). This may provide data communication, power supply, or internet connection to the device (900). In addition, the sensing unit (503) can be further integrated with at least one environmental-detecting unit for measuring environmental factors within a space (e.g. temperature, pressure, humidity). The environmental-detecting unit may comprise at least one environmental-detecting sensor selected from temperature sensor, pressure sensor, humidity sensor, vibration sensor, flame sensor, smoke sensor and the like for detecting or measuring other physical properties within the space according to user needs.

One advantage of the system (100) with the sensing unit (503) among others is that it can also detect and monitor the force acting on the device (900). For example, in the facility, if the system (100) is installed on the floor which is equipped with pipes (regarded as device (900)), and if there is force applied to the pipes, such as from people walking or instruments overlaying thereon, the post-stage compression force would be higher. The compression detecting unit (508) will detect the post-stage compression force that is increased, and then transmit it to the processor (600) in order to notify to workers to check whether there is any damage to the pipes. This provides more safety and security to the facility.

The devices (900) may be selected from: a battery storage unit, data storage unit, camera, microphone, speaker, light, spotlight, sound and light measurement controller, wireless controller, monitor, touch screen display, VR controller, VR display, projector, television, kitchen appliances, solar cell, solar panel, computer controller (such as joystick and gaming wheel), mobile controller, charger, water dispenser, air purifier, cooling fan, electric fan, air conditioning unit, heater, heat transfer unit, infrared laser light, or any kind of sensors (e.g. temperature sensor, humidity sensor, force sensor, hall sensor), or any structure material embedded with electronic board, or any kind of IoT device having the same connecting part to connect with previously mentioned cables or junction unit of the present invention, without any purpose to limit any scope of the invention.

All the examples of the panel system (100) disclosed in this document are not limited to the construction of a wall, but also to construct partitions, ceilings and floors for homes, offices, conference rooms, education places, gaming rooms, VR rooms, hologram rooms, hospitals, operating rooms, robotic rooms, testing/experiment rooms, containers, any kind of building, or any type of construction involving walls, ceilings and floors, without any purpose to limit any scope of the invention.

The panel system (100) can also adjust/modify the material of any components to suit the environment and atmosphere in that area, whether it is used in a normal atmosphere, under the sea level where materials resistant to corrosion are required, or in the case of use in outer space (extremely high vacuum) where lightweight and very strong materials are required. While the property of the material may be changed, and is expected by an ordinary person skilled in the art, the components and functions would not differ from the scope of the present invention.

While an embodiment of the invention has been illustrated and described, it is appreciated that various changes can be made therein without departing from the spirit and scope of the invention.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features provided in the described embodiments shall not limit the application of such issued claims to processes and structures accomplishing any or all of the above advantages.

### BEST MODE OR PREFERRED EMBODIMENT OF THE INVENTION

Best mode or preferred embodiment of the invention is as provided in the description of the invention.

1. A panel system comprising:
a. a plurality of supporting panels;
b. a plurality of mounting modules for supporting installation of device where the mounting modules are configured to lower load of the device upon installation;
c. at least one cable track formed at at least one edge of the mounting module for supporting a cable module
d. the cable module installed in the cable track;
e. at least one device in connection to the cable module
f. a processor in connection to the cable module and the device
wherein the cable module is fully or partially installed in the cable track in a predetermined direction to transmit power and signal to an adjustably predetermined position of the device and the processor is configured to process desired data from the device for executing a plurality of functions.

2. The panel system according to claim 1, wherein the system further comprises at least one additional panel attached back-to-back of the supporting panel

3. The panel system according to claim 2, wherein the system further comprises a securing module to securely attach supporting panels with additional panel.

4. The panel system according to claim 2, wherein the supporting panel and additional panel are the same or different size.

5. The system according to claim 2, wherein the system further comprises an insulating material provided between the supporting panel and the additional panel.

6. The panel system according to claim 1, wherein the cable module comprises at least one cable and at least one junction unit.

7. The panel system according to claim 6, wherein the cable and the junction unit are printed circuit board (PCB).

8. The panel system according to claim 6, wherein the cable comprises
two connecting parts located at both ends of the cable;
a first conductive material layer;
an insulation layer attached under the first conductive material layer;
a second conductive material layer, attached under the insulation layer, where the second conductive material layer comprises a ground plane and a power plane.

9. The panel system according to claim 8, wherein the cable further comprises mask layers disposed on the first conductive material layer and on the second conductive material layer for preventing oxidation of the conductive material.

10. The panel system according to claim 6, wherein the junction unit comprises
at least three connecting parts located at the end of the junction unit;
a first conductive material layer, where the first conductive material layer comprises a power plane;
an insulation layer attached under the first conductive material layer;
a second conductive material layer attached under the insulation layer, where the second conductive material layer comprises a ground plane.

11. The panel system according to claim 10, wherein the junction unit further comprises mask layers disposed on the first conductive material layer and on the second conductive material layer for preventing oxidation of the conductive material.

12. The panel system according to claim 8, wherein the connecting part comprises at least one pin of Voltage Common Collector (VCC), at least one pin of ground (GND), and at least one pin of signal.

13. The panel system according to claim 12, wherein the connecting part comprises 3-pin Voltage Common Collector (VCC), 4-pin ground (GND), and 4-pin of signal.

14. The panel system according to claim 13, wherein a type of the signal is selected from RS-232, RS-422, RS-423, RS-485, I²C, Ethernet, SDI-12, 1-Wire or combination thereof.

15. The panel system according to claim 14, wherein the type of the signal is RS-485.

16. The panel system according to claim 1, wherein the mounting module further comprises:
at least one permanent electromagnet for mounting the device where the permanent electromagnet is in a fully magnetized stage with no electrical current applied;
a sensing unit configured to sense the device attached on the permanent electromagnet, comprising
at least one identity detecting unit for detecting an identity of the device
at least one magnetic detecting unit for detecting a magnetic field between the device and the permanent electromagnet;
at least one compression detecting unit for detecting a compression force between the device and the permanent electromagnet.

17. The panel system according to claim 16, wherein the processor is further configured to control the identity detecting unit, magnetic detecting unit and compression detecting unit

18. The panel system according to claim 1, wherein the mounting module is further configured to:
i) partially reducing a magnetic field from an initial magnetic field of the permanent electromagnet by applying a power thereto;
ii) detecting a magnetic field via the magnetic detecting unit and a compression force via the compression detecting unit, when the device is mounted to the permanent electromagnet by a user;
iii) receiving and verifying the identity of the device from the identity detecting unit, if the identity of the device is not accurate, the processor will notify the user;
iv) terminating applying the power to fully attach the device after receiving to the user's instruction;
wherein step i) the electrical current will be applied in order to reduce the magnetic field of the permanent electromagnet to be able to temporarily attach at least 70% of weight of the object.
